(19) United States
(12) Patent Application Publication
(10) Pub. No.: US 2013/0086564 A1
(43) Pub. Date: Apr. 4, 2013

(54) METHODS AND SYSTEMS FOR OPTIMIZING EXECUTION OF A PROGRAM IN AN ENVIRONMENT HAVING SIMULTANEOUSLY PARALLEL AND SERIAL PROCESSING CAPABILITY

(71) Applicant: Andrew C. FELCH, Palo Alto, CA (US)

(72) Inventor: Andrew C. FELCH, Palo Alto, CA (US)

(73) Assignee: COGNITIVE ELECTRONICS, INC., Lebanon, NH (US)

(21) Appl. No.: 13/594,137

(22) Filed: Aug. 24, 2012

Related U.S. Application Data
(60) Provisional application No. 61/528,071, filed on Aug. 26, 2011.

(51) Int. Cl. G06F 9/45

(52) U.S. Cl. CPC G06F 8/41
USPC 717/145

(57) ABSTRACT

An automated method of optimizing execution of a program in a parallel processing environment is disclosed. The program has a plurality of threads and is executable in parallel and serial hardware. The method includes receiving the program at an optimizer and compiling the program to execute in parallel hardware. The execution of the program is observed by the optimizer to identify a subset of memory operations that execute more efficiently on serial hardware than parallel hardware. A subset of memory operations that execute more efficiently on parallel hardware than serial hardware are identified. The program is recompiled so that threads that include memory operations that execute more efficiently on serial hardware than parallel hardware are compiled for serial hardware, and threads that include memory operations that execute more efficiently on parallel hardware than serial hardware are compiled for parallel hardware. Subsequent execution of the program occurs using the recompiled program.

### CROSS-REFERENCE TO RELATED APPLICATIONS

This application claims priority to U.S. Provisional Patent Application No. 61/528,071 filed Aug. 26, 2011, which is incorporated herein by reference.

### BACKGROUND OF THE INVENTION

Applications requiring more performance than any single computer can deliver can be run on multiple computers in parallel configurations. This technique has long been used in high performance computing. The individual computers may themselves be optimized for serial or parallel execution, and the choice of which hardware to run a program on can have significant impact on the final performance of the cluster. Some applications may benefit from running certain components on parallel hardware and other components on serial hardware.

Programming for multiple different computer architectures has historically required special programming techniques. Accordingly, it is desirable to automatically suggest and carry out suggestions of how an application should be distributed across a cluster of serial and parallel hardware. It is further desirable to automatically examine execution of a program on parallel hardware in order to generate suggestions as to how the program should be segregated amongst the various available hardware.

### BRIEF DESCRIPTION OF THE INVENTION

In one embodiment, an automated method of optimizing execution of a program in a parallel processing environment is disclosed. The program has a plurality of threads and is executable in parallel and serial hardware. The method includes receiving the program at an optimizer and compiling the program to execute in parallel hardware upon instruction by the optimizer. The program is executed on the parallel hardware. The execution of the program is observed by the optimizer to identify a subset of memory operations that execute more efficiently on serial hardware than parallel hardware. The optimizer observes the execution of the program and identifies a subset of memory operations that execute more efficiently on parallel hardware than serial hardware. The optimizer recompiles the program so that threads that include memory operations that execute more efficiently on serial hardware than parallel hardware are compiled for serial hardware, and threads that include memory operations that execute more efficiently on parallel hardware than serial hardware are compiled for parallel hardware. Subsequent execution of the program occurs using the recompiled program.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an overview of a parallel computing architecture;

FIG. 2 is an illustration of a program counter selector for use with the parallel computing architecture of FIG. 1;

FIG. 3 is a block diagram showing an example state of the architecture;

FIG. 4 is a block diagram illustrating cycles of operation during which eight Virtual Processors execute the same program but starting at different points of execution;

FIG. 5 is a block diagram of a multi-core system-on-chip;

FIG. 6 is an illustration of a technique for optimizing and reorganizing a computer program's execution between parallel hardware and serial hardware in accordance with one preferred embodiment of this invention;

FIG. 7 is an example of a program that may be run on the parallel computing architecture of FIG. 2 in accordance with the preferred embodiment of this invention;

FIG. 8 shows log entries for execution of Thread 0 of the program of FIG. 7 in accordance with one preferred embodiment of this invention;

FIG. 9 shows log entries for execution of Threads 1-7 of the program of FIG. 7 in accordance with one preferred embodiment of this invention;

FIG. 10 shows log entries for execution of Threads 8-11 of the program of FIG. 7 in accordance with one preferred embodiment of this invention;

FIG. 11 shows a first portion of an analysis program in accordance with one preferred embodiment of this invention;

FIG. 12 shows a second portion of an analysis program for selecting threads for parallel or serial execution in accordance with one preferred embodiment of this invention;

FIG. 13 is a block diagram illustrating the memory hierarchy of parallel computing hardware of FIGS. 2-6 in accordance with one preferred embodiment of this invention;

FIG. 14 is a block diagram illustrating the memory hierarchy of serial computing hardware in accordance with one preferred embodiment of this invention

FIG. 15 shows the results of the analysis program of FIGS. 11 and 12 for the program of FIG. 7, specifying which threads should be run on parallel hardware and which should be run on serial hardware in accordance with one preferred embodiment of this invention;

FIG. 16 is an example of a report of suggested alternations to the program of FIG. 7 that can improve performance, determined based on the analysis of the analysis program of FIGS. 11 and 12 in accordance with one preferred embodiment of this invention;

FIG. 17 shows the process of executing a program on parallel hardware and the serial hardware, given the thread hardware specification shown in FIG. 15 in accordance with one preferred embodiment of this invention; and

FIG. 18 shows an example work report generated by thread 7 of the execution of the program of FIG. 7 in accordance with one preferred embodiment of this invention.

### DETAILED DESCRIPTION OF THE INVENTION

### Definitions

The following definitions are provided to promote understanding of the invention:

Serial hardware—Hardware that, though it may be capable of running parallel software, is able to dedicate most or all of the resources within an individual core to an individual thread. Serial hardware processor cores are capable of running at high frequency (e.g. 2 ghz) when not in power saving mode. Generally, fewer threads are required to run in parallel to achieve a given amount of performance on serial processor cores, and generally more memory is available per thread (e.g. 1 GB) because there is a high ratio of memory to number of potential threads executing in parallel on serial hardware cores. Given a single program thread, serial hardware can achieve higher performance than parallel hardware.

Example serial hardware can be found in the Intel Nehalem processor, which achieves 3.2 ghz and can increase the clock speed of one of a small number of the onboard processor cores within a chip so that programs containing just a single thread are able to execute even more quickly. In a typical Intel Nehalem system there will be 8 hardware threads and 8 GB-24 GB of memory per processor, corresponding to 1 GB-3 GB per hardware thread. Similarly, the IBM Power 6 processor, which achieved greater than 5 ghz frequency can be described as serial hardware.

Parallel hardware—Hardware optimized to execute multiple threads at the same time and unable to dedicate all of a processor core's resources to a single thread. Parallel hardware cores generally run at lower frequency (e.g. 500 mhz) to reduce power consumption so that more cores can be fit on the same chip without overheating. Given a large or unlimited number of threads, parallel hardware will achieve higher performance than serial hardware for a given amount of power consumption. Alternatively, given a large or unlimited number of threads the parallel hardware can achieve the same performance as serial hardware while consuming less power.

Example parallel hardware can be found in the architecture described below, as well as in the ATI RADEON graphics processors, which run at 500 mhz-1 Ghz, and NVIDIA CUDA graphics processors which run at ˜1.5 ghz. These processors support thousands of threads and contain only 2 GB-4 GB of memory, resulting in relatively low memory per thread in the range of 100 KB-LOMB when running an efficient number of threads. Furthermore performance on these two processors is poor when only one thread is being run.

Threads and processes—A thread of execution is defined as a unit of processing that can be scheduled by an operating system. More specifically, it is the smallest schedulable unit of execution. Note that although the terminology of “thread” will be used throughout, this invention pertains also to “processes”, which are threads that do not share memory with each other. It is noteworthy that in the case that some threads are run on serial hardware and some on parallel hardware, that if there are shared data structures accessed by some of the threads executing on parallel hardware, and some of the threads on serial hardware, that the architecture must support either shared memory between the two architectures. In the case that processes (threads that do not share memory) are being distributed amongst serial and parallel hardware, this is not an issue as there are no data structures that are shared in memory between processes. It is preferable that the threads running on serial hardware and the threads running on parallel hardware do not share any memory or do not access shared memory structures frequently or in performance critical portions of the program.

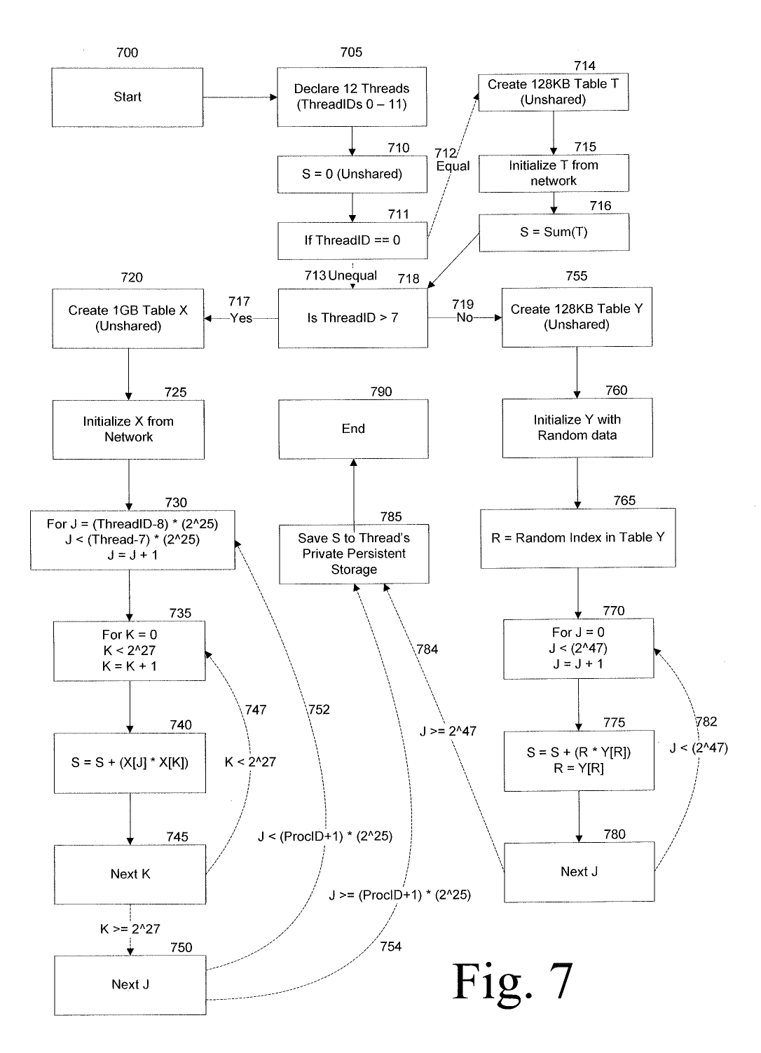

Furthermore, additional changes to the program may be required to support sharing of data structures between the two hardware architectures. For example, a server such as memcached may be used and code accessing the shared data structures would need to be changed to perform explicit manipulation of data stored on the separate network-attached-memory supplied by memcached. With this in mind, the example program of FIG. 7 will not share memory and thus the situation of how to share data structures between parallel and serial hardware does not arise.

### Example Existing System not Implementing all Functions of Novel System

As an example of a system that implements some non-novel steps included in the novel system is the Nvidia CUDA optimizing compiler. The CUDA optimizing compiler receives a program and compiles it for execution on parallel hardware (CUDA-compatible Graphics Processing Units). The CUDA optimizing compiler is capable of carrying out some optimizations for programs such as selecting special instructions that carry out multiple operations. The CUDA optimizing compiler can initiate execution of the compiled program on parallel hardware as in CUDA-compatible Graphics Processing Units (GPUs). The CUDA optimizing compiler does not analyze how a program has executed in order determine if portions of a program's execution should move to serial hardware. The CUDA optimizing compiler also does not take steps to move such execution to serial hardware.

### DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

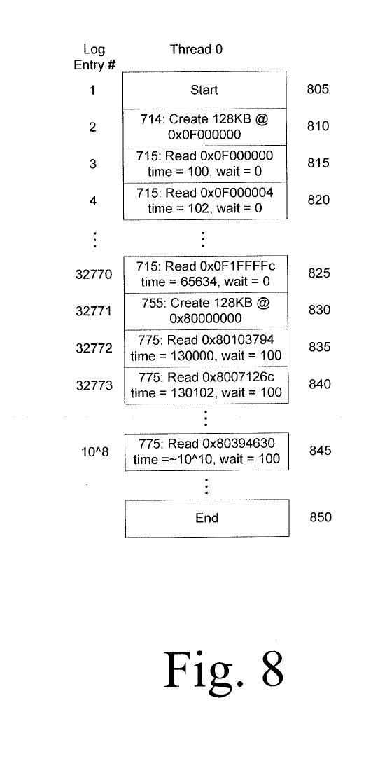

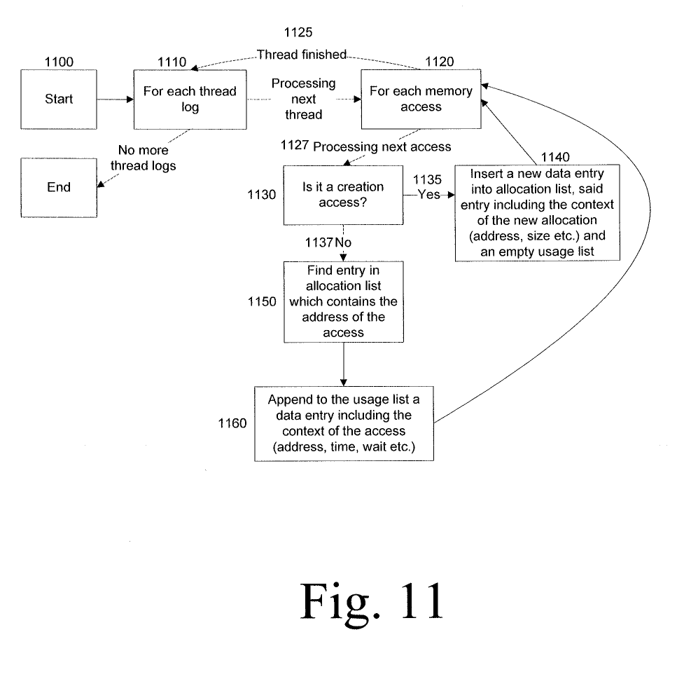

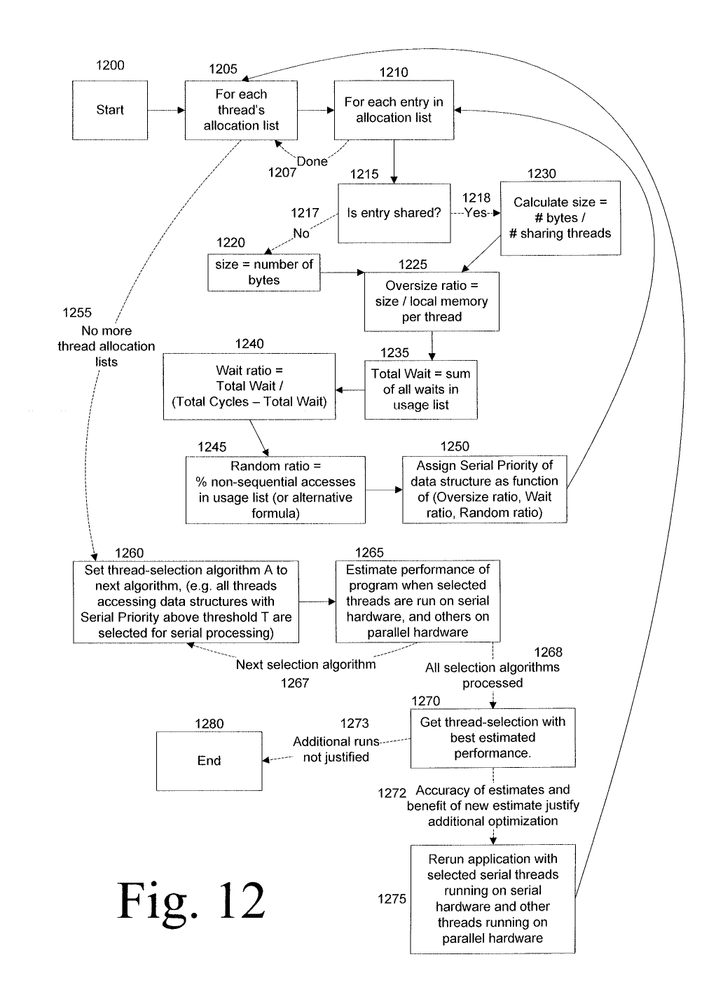

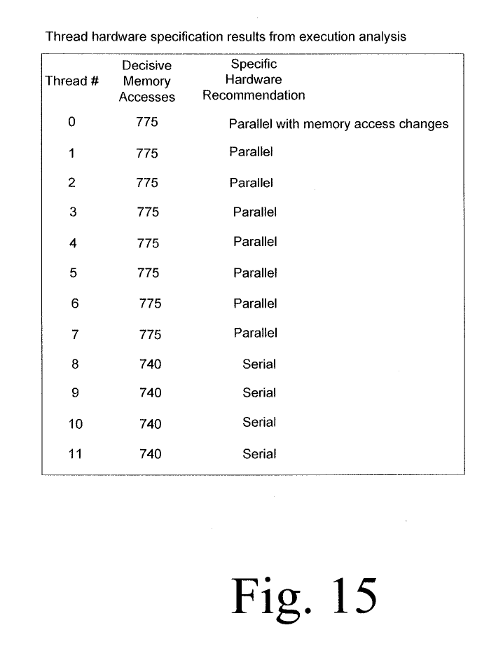

Referring to the drawings in detail, wherein like reference numerals indicate like elements throughout, techniques for optimizing segmentation of execution of a computer program between parallel hardware and serial hardware are shown. FIG. 7 shows an example program that may be run on parallel hardware. Execution of the program may be observed and based on the observation, logs (shown in FIGS. 8-10) are created. These logs are analyzed using the analysis program shown in FIGS. 11 and 12 in order to determine the analysis results, shown in FIG. 15. The analysis results shown in FIG. 15 specify which threads should be run on parallel hardware and which should be run on serial hardware. The analysis results are further analyzed to specify where each data structure should be allocated memory.

Parallel Computing Architecture

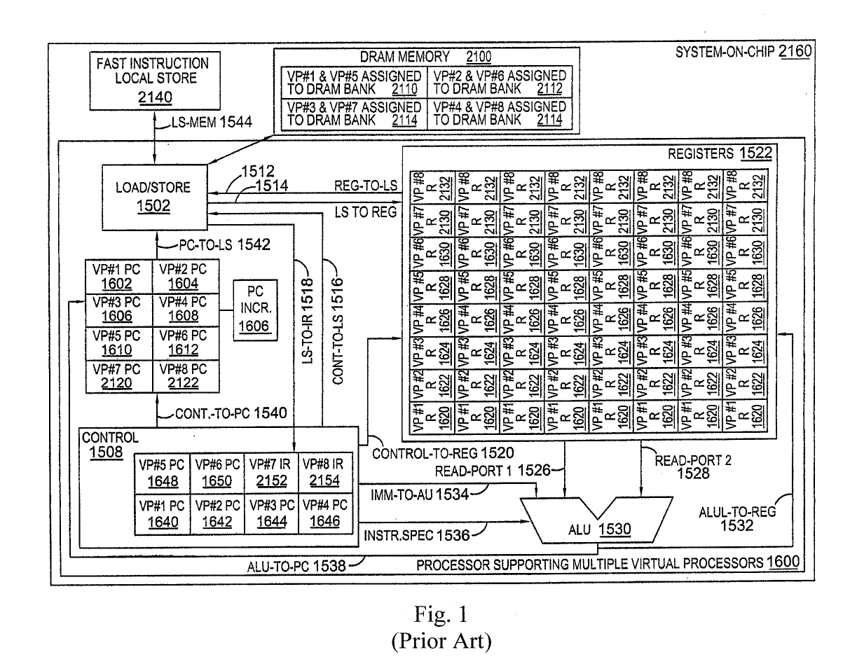

The following parallel computing architecture is one example of an architecture that may be used to implement the features of this invention. The architecture is further described in U.S. Patent Application Publication No. 2009/0083263 (Felch et al.), which is incorporated by reference herein. FIG. 1 is a block diagram schematic of a processor architecture 2160 utilizing on-chip DRAM (2100) memory storage as the primary data storage mechanism and Fast Instruction Local Store, or just Instruction Store, 2140 as the primary memory from which instructions are fetched. The Instruction Store 2140 is fast and is preferably implemented using SRAM memory. In order for the Instruction Store 2140 to not consume too much power relative to the microprocessor and DRAM memory, the Instruction Store 2140 can be made very small. Instructions that do not fit in the SRAM are stored in and fetched from the DRAM memory 2100. Since instruction fetches from DRAM memory are significantly slower than from SRAM memory, it is preferable to store performance-critical code of a program in SRAM. Performance-critical code is usually a small set of instructions that are repeated many times during execution of the program.

The DRAM memory 2100 is organized into four banks 2110, 2112, 2114 and 2116, and requires 4 processor cycles to complete, called a 4-cycle latency. In order to allow such instructions to execute during a single Execute stage of the Instruction, eight virtual processors are provided, including new VP#7 (2120) and VP#8 (2122). Thus, the DRAM memories 2100 are able to perform two memory operations for every Virtual Processor cycle by assigning the tasks of two processors (for example VP#1 and VP#5 to bank 2110). By elongating the Execute stage to 4 cycles, and maintaining single-cycle stages for the other 4 stages comprising: Instruction Fetch, Decode and Dispatch, Write Results, and Increment PC; it is possible for each virtual processor to complete an entire instruction cycle during each virtual processor cycle. For example, at hardware processor cycle T=1 Virtual Processor #1 (VP#1) might be at the Fetch instruction cycle. Thus, at T=2 Virtual Processor #1 (VP#1) will perform a Decode & Dispatch stage. At T=3 the Virtual Processor will begin the Execute stage of the instruction cycle, which will take 4 hardware cycles (half a Virtual Processor cycle since there are 8 Virtual Processors) regardless of whether the instruction is a memory operation or an ALU 1530 function. If the instruction is an ALU instruction, the Virtual Processor might spend cycles 4, 5, and 6 simply waiting. It is noteworthy that although the Virtual Processor is waiting, the ALU is still servicing a different Virtual Processor (processing any non-memory instructions) every hardware cycle and is preferably not idling. The same is true for the rest of the processor except the additional registers consumed by the waiting Virtual Processor, which are in fact idling. Although this architecture may seem slow at first glance, the hardware is being fully utilized at the expense of additional hardware registers required by the Virtual Processors. By minimizing the number of registers required for each Virtual Processor, the overhead of these registers can be reduced. Although a reduction in usable registers could drastically reduce the performance of an architecture, the high bandwidth availability of the DRAM memory reduces the penalty paid to move data between the small number of registers and the DRAM memory.

This architecture 1600 implements separate instruction cycles for each virtual processor in a staggered fashion such that at any given moment exactly one VP is performing Instruction Fetch, one VP is Decoding Instruction, one VP is Dispatching Register Operands, one VP is Executing Instruction, and one VP is Writing Results. Each VP is performing a step in the Instruction Cycle that no other VP is doing. The entire processor's 1600 resources are utilized every cycle. Compared to the naïve processor 1500 this new processor could execute instructions six times faster.

As an example processor cycle, suppose that VP#6 is currently fetching an instruction using VP#6 PC 1612 to designate which instruction to fetch, which will be stored in VP#6 Instruction Register 1650. This means that VP#5 is Incrementing VP#5 PC 1610, VP#4 is Decoding an instruction in VP#4 Instruction Register 1646 that was fetched two cycles earlier. VP #3 is Dispatching Register Operands. These register operands are only selected from VP#3 Registers 1624. VP#2 is Executing the instruction using VP#2 Register 1622 operands that were dispatched during the previous cycle. VP#1 is Writing Results to either VP#1 PC 1602 or a VP#1 Register 1620.

During the next processor cycle, each Virtual Processor will move on to the next stage in the instruction cycle. Since VP#1 just finished completing an instruction cycle it will start a new instruction cycle, beginning with the first stage, Fetch Instruction.

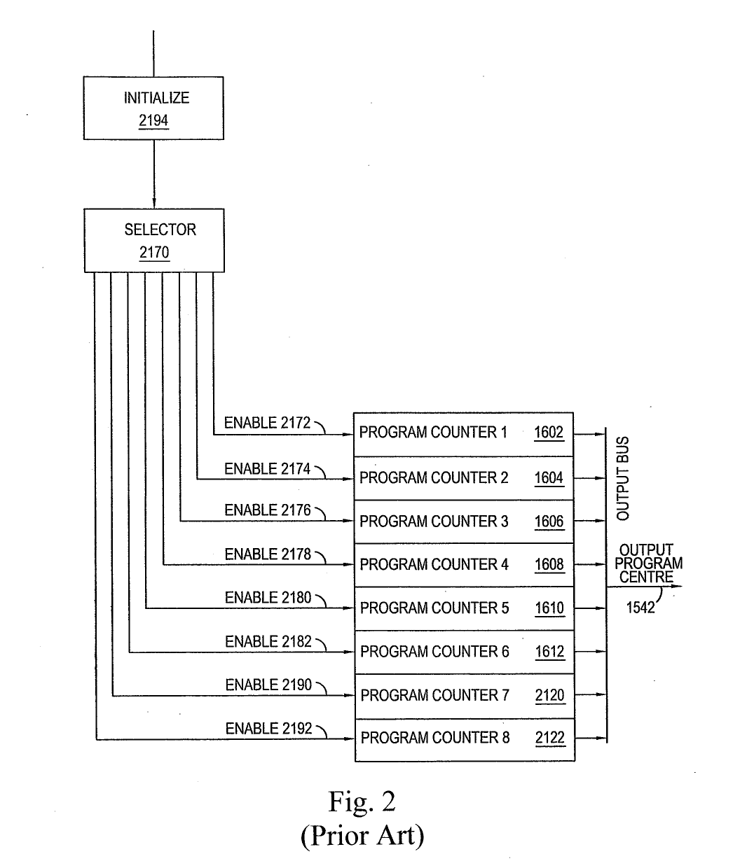

Note, in the architecture 2160, in conjunction with the additional virtual processors VP#7 and VP#8, the system control 1508 now includes VP#7 IR 2152 and VP#8 IR 2154. In addition, the registers for VP#7 (2132) and VP#8 (2134) have been added to the register block 1522. Moreover, with reference to FIG. 2, a Selector function 2110 is provided within the control 1508 to control the selection operation of each virtual processor VP#1-VP#8, thereby maintaining the orderly execution of tasks/threads, and optimizing advantages of the virtual processor architecture the has one output for each program counter and enables one of these every cycle. The enabled program counter will send its program counter value to the output bus, based upon the direction of the selector 2170 via each enable line 2172, 2174, 2176, 2178, 2180, 2182, 2190, 2192. This value will be received by Instruction Fetch unit 2140. In this configuration the Instruction Fetch unit 2140 need only support one input pathway, and each cycle the selector ensures that the respective program counter received by the Instruction Fetch unit 2140 is the correct one scheduled for that cycle. When the Selector 2170 receives an initialize input 2194, it resets to the beginning of its schedule. An example schedule would output Program Counter 1 during cycle 1, Program Counter 2 during cycle 2, etc. and Program Counter 8 during cycle 8, and starting the schedule over during cycle 9 to output Program Counter 1 during cycle 9, and so on . . . . A version of the selector function is applicable to any of the embodiments described herein in which a plurality of virtual processors are provided.

To complete the example, during hardware-cycle T=7 Virtual Processor #1 performs the Write Results stage, at T=8 Virtual Processor #1 (VP#1) performs the Increment PC stage, and will begin a new instruction cycle at T=9. In another example, the Virtual Processor may perform a memory operation during the Execute stage, which will require 4 cycles, from T=3 to T=6 in the previous example. This enables the architecture to use DRAM 2100 as a low-power, high-capacity data storage in place of a SRAM data cache by accommodating the higher latency of DRAM, thus improving power-efficiency. A feature of this architecture is that Virtual Processes pay no performance penalty for randomly accessing memory held within its assigned bank. This is quite a contrast to some high-speed architectures that use high-speed SRAM data cache, which is still typically not fast enough to retrieve data in a single cycle.

Each DRAM memory bank can be architected so as to use a comparable (or less) amount of power relative to the power consumption of the processor(s) it is locally serving. One method is to sufficiently share DRAM logic resources, such as those that select rows and read bit lines. During much of DRAM operations the logic is idling and merely asserting a previously calculated value. Using simple latches in these circuits would allow these assertions to continue and free-up the idling DRAM logic resources to serve other banks. Thus the DRAM logic resources could operate in a pipelined fashion to achieve better area efficiency and power efficiency.

Another method for reducing the power consumption of DRAM memory is to reduce the number of bits that are sensed during a memory operation. This can be done by decreasing the number of columns in a memory bank. This allows memory capacity to be traded for reduced power consumption, thus allowing the memory banks and processors to be balanced and use comparable power to each other.

The DRAM memory 2100 can be optimized for power efficiency by performing memory operations using chunks, also called “words”, that are as small as possible while still being sufficient for performance-critical sections of code. One such method might retrieve data in 32-bit chunks if registers on the CPU use 32-bits. Another method might optimize the memory chunks for use with instruction Fetch. For example, such a method might use 80-bit chunks in the case that instructions must often be fetched from data memory and the instructions are typically 80 bits or are a maximum of 80 bits.

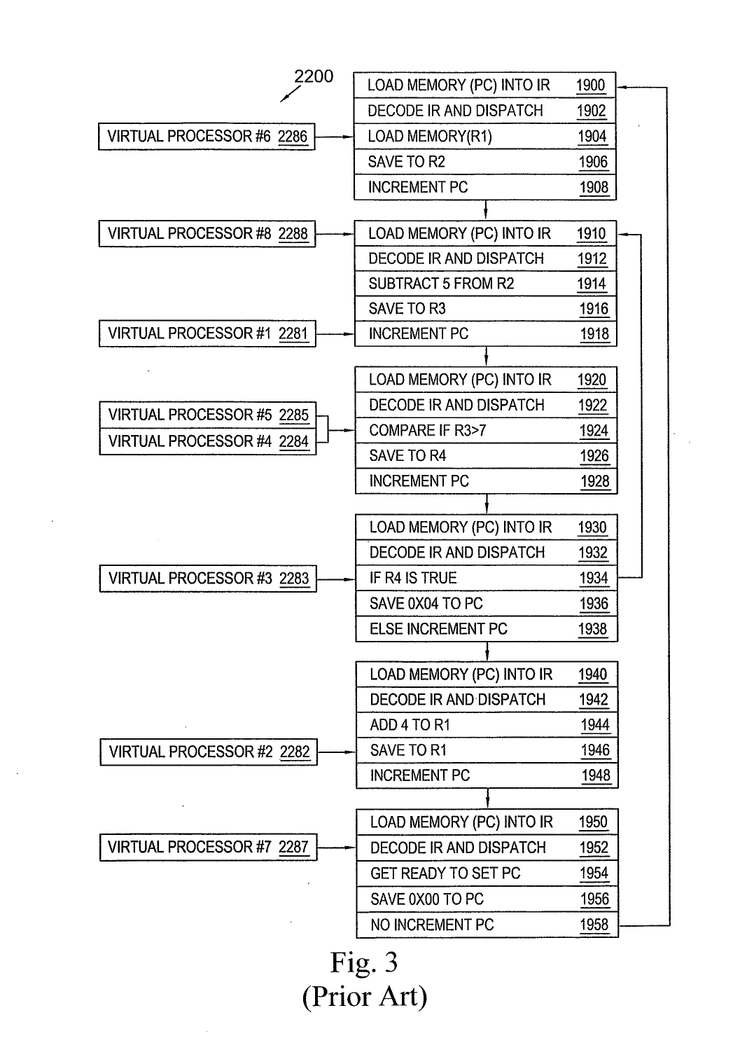

FIG. 3 is a bock diagram 2200 showing an example state of the architecture 2160 in FIG. 1. Because DRAM memory access requires four cycles to complete, the Execute stage (1904, 1914, 1924, 1934, 1944, 1954) is allotted four cycles to complete, regardless of the instruction being executed. For this reason there will always be four virtual processors waiting in the Execute stage. In this example these four virtual processors are VP#3 (2283) executing a branch instruction 1934, VP#4 (2284) executing a comparison instruction 1924, VP#5 2285 executing a comparison instruction 1924, and VP#6 (2286) a memory instruction. The Fetch stage (1900, 1910, 1920, 1940, 1950) requires only one stage cycle to complete due to the use of a high-speed instruction store 2140. In the example, VP#8 (2288) is in the VP in the Fetch Instruction stage 1910. The Decode and Dispatch stage (1902, 1912, 1922, 1932, 1942, 1952) also requires just one cycle to complete, and in this example VP#7 (2287) is executing this stage 1952. The Write Result stage (1906, 1916, 1926, 1936, 1946, 1956) also requires only one cycle to complete, and in this example VP#2 (2282) is executing this stage 1946. The Increment PC stage (1908, 1918, 1928, 1938, 1948, 1958) also requires only one stage to complete, and in this example VP#1 (1981) is executing this stage 1918. This snapshot of a microprocessor executing 8 Virtual Processors (2281-2288) will be used as a starting point for a sequential analysis in the next figure.

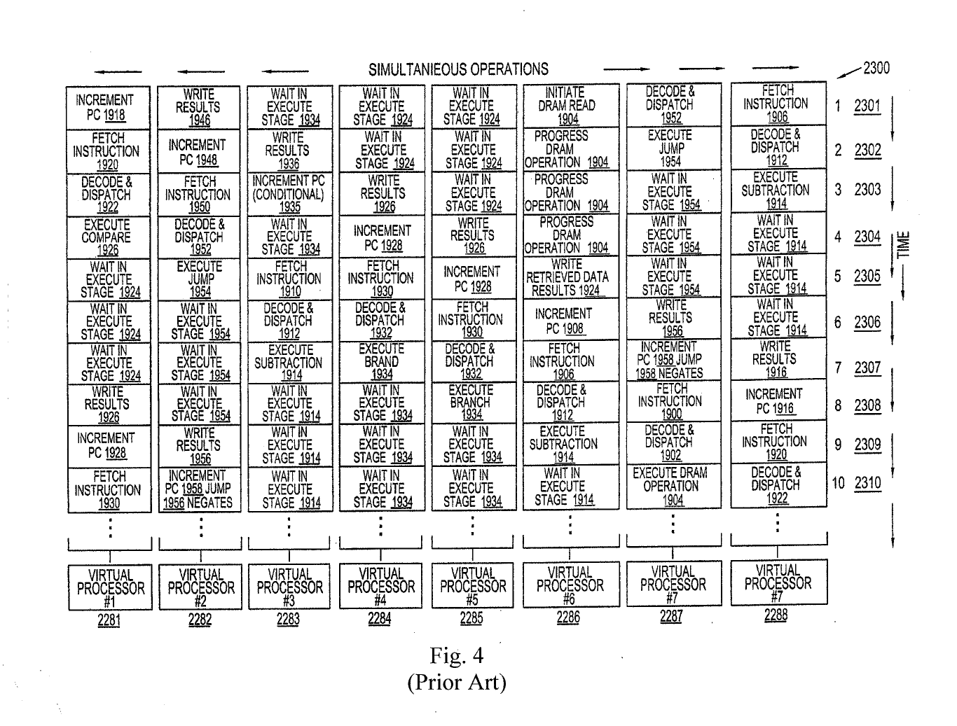

FIG. 4 is a block diagram 2300 illustrating 10 cycles of operation during which 8 Virtual Processors (2281-2288) execute the same program but starting at different points of execution. At any point in time (2301-2310) it can be seen that all Instruction Cycle stages are being performed by different Virtual Processors (2281-2288) at the same time. In addition, three of the Virtual Processors (2281-2288) are waiting in the execution stage, and, if the executing instruction is a memory operation, this process is waiting for the memory operation to complete. More specifically in the case of a memory READ instruction this process is waiting for the memory data to arrive from the DRAM memory banks This is the case for VP#8 (2288) at times T=4, T=5, and T=6 (2304, 2305, 2306).

When virtual processors are able to perform their memory operations using only local DRAM memory, the example architecture is able to operate in a real-time fashion because all of these instructions execute for a fixed duration.

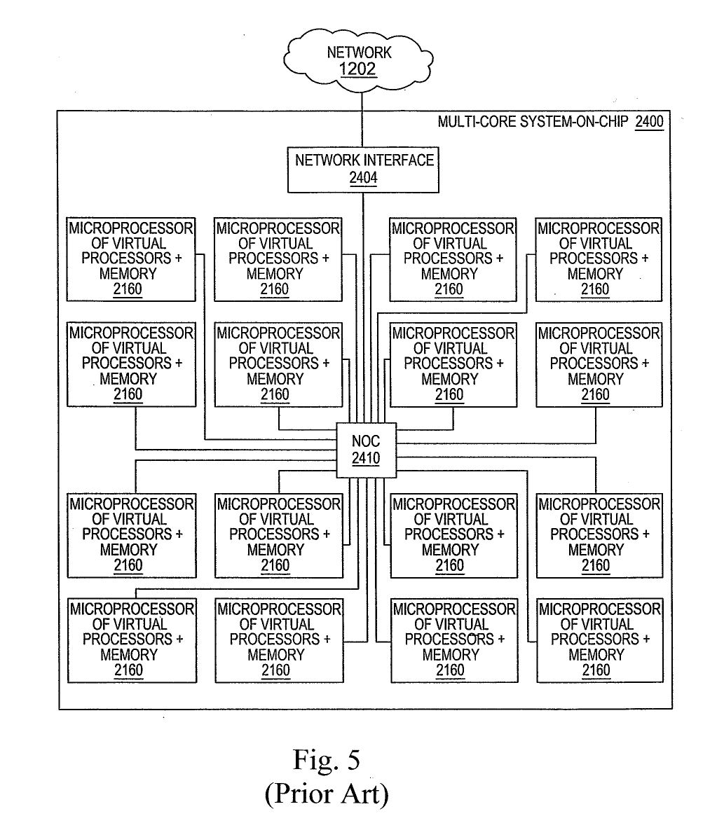

FIG. 5 is a block diagram of a multi-core system-on-chip 2400. Each core is a microprocessor implementing multiple virtual processors and multiple banks of DRAM memory 2160. The microprocessors interface with a network-on-chip (NOC) 2410 switch such as a crossbar switch. The architecture sacrifices total available bandwidth, if necessary, to reduce the power consumption of the network-on-chip such that it does not impact overall chip power consumption beyond a tolerable threshold. The network interface 2404 communicates with the microprocessors using the same protocol the microprocessors use to communicate with each other over the NOC 2410. If an IP core (licensable chip component) implements a desired network interface, an adapter circuit may be used to translate microprocessor communication to the on-chip interface of the network interface IP core.

Program Analysis

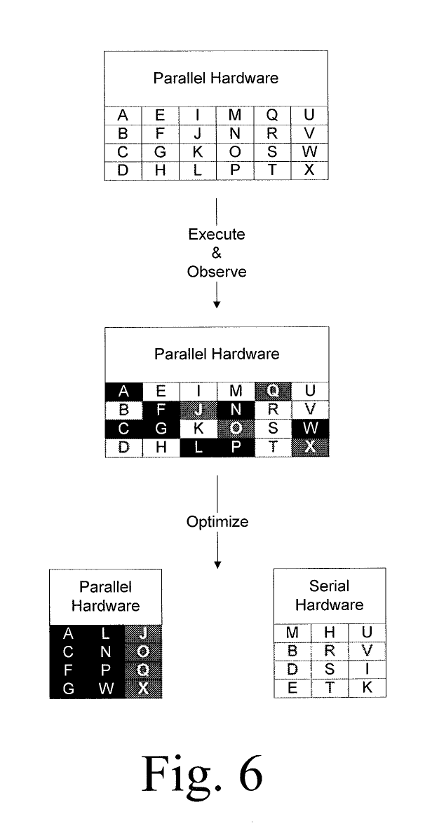

FIG. 6 shows a method for optimizing a program for segmented execution on parallel hardware 100 and serial hardware 110. The program has a plurality of threads A-X. When optimized, threads whose performance depends on memory operations that are well-suited to execute on parallel hardware are automatically run on parallel hardware 100, and threads whose performance depends on memory operations better suited for execution on serial hardware are automatically run on serial hardware 110. The lettered boxes in each of the figures above indicate different threads executing in a program, the same thread is referred to by the same letter in each set of boxes.

In order to optimize the program, threads of the program are initially compiled to run only on parallel hardware 100. Memory operations of the threads during execution on the parallel hardware 100 are observed. The box in the middle of FIG. 6 shows the results of an execution of the program on the parallel hardware 100. The darker boxes indicate memory operations that were observed to be well-suited to parallel hardware whereas the lighter-shaded boxes indicate threads that were observed to contain memory operations relatively less well-suited for execution on parallel hardware. These threads in the lighter-shaded boxes are better-suited for execution on serial hardware. As shown in the bottom set of FIG. 6, the optimizer recompiles the program so that threads with memory operations better-suited for parallel hardware run on parallel hardware 100 and those better-suited for serial hardware run on serial hardware 110.

Preferably, to facilitate the observation of the memory operations, threads report to the optimizer when they have completed a unit of work. The optimizer is a computer system that identifies and indicates non-automatic improvements to the program that may be made automatically or by the user. For example, the optimizer may identify lines of code that contain memory operations that currently inhibit the execution of threads on parallel hardware. Memory allocation may be improved by placing data associated with frequently accessed memory operations into memory that is faster than the memory that is used for other data.

FIG. 7 shows a program comprising multiple threads. The program starts at step 700 and proceeds immediately to step 705 of the program. In step 705, twelve threads are initiated, all of these threads start at step 710. In an actual implementation in which twelve threads are desired, eleven threads may be declared and the initial thread may remain active. Alternatively, twelve threads may be declared and the initial thread may wait until all twelve threads have signaled that they have finished their jobs.

The program is initiated at step 705 through, for example, a command line input which executes the program on a selected architecture and specifies a number of processes to run the program. For example, where the command “mpirun” is used, the operation may be “mpirun -arch parallel -np 12 program.cognitive”. This specifies to run the “program.cognitive” program on the parallel architecture with twelve processors/processes.

All twelve threads begin execution at step 710, where the threads each initialize their own private variable S to zero. The term “unshared” will be used to indicate that data structures are created individually for each thread that executes that step, as in step 710. At step 711, each thread compares its own ThreadID (numbered from 0 to 11) with the value of zero. Therefore, the first thread, which has the ThreadID of zero proceeds via arrow 712 to step 714. The other threads (1-11) proceed via arrow 713 to step 718.

Execution of Thread 0 will now be considered. At step 714, Thread 0 creates a 128 kilobyte (“KB”) table data structure named “T”, which is unshared. In this illustrative embodiment, threads have an individual 256 KB of local memory to hold data. Some of the memory is dedicated to stack and thread-specific data and some of the memory is dedicated to joining a shared pool spread amongst all of the threads on the chip. Therefore, it is possible for the local memory to hold this 128 KB table; however, a second table would not fit in this same local memory and would have to be allocated either in the shared pool or else off-chip. The shared on-chip pool is likely to have worse performance characteristics that the local memory and is also likely to be unavailable, as it is shared amongst many threads. Similarly, the off-chip memory is significantly lower performance than the local memory. Thus, it is important for the memory that is used most to be local so that accesses to lower performance memory are minimized.

With table T allocated locally for Thread 0, Thread 0 then proceeds to step 715 in which the table T is initialized from the network. Thread 0 then proceeds to step 716 where the variable S is updated to be equal to the sum of all of the values stored in T. Subsequently, Thread 0 proceeds to step 718 which will also previously have been executed by all of the other threads. We will consider their processing together since it does not affect the outcome of the example.

All twelve threads encounter step 718 where the Thread ID is compared with the value 7. All threads with ThreadIDs greater than 7 (Threads 8-11) proceed via arrow 717 to step 720. Threads 0-7 proceed via arrow 719 to step 755. We will follow the execution path of threads 0-7 before returning to follow the path of threads 8-11.

Threads 0-7 execute at step 755, where they each allocate a table variable “Y” which is 128 KB and used by the thread privately. Threads 1-7 allocate this variable locally and therefore accesses to Y will have less delay and result in higher performance. However since Thread 0 previously consumed half of its local memory with table T, Thread 0's local memory can no longer fit a new table of size 128 KB. Therefore, Thread 0 allocates memory space for table Y non-locally. In this illustrative embodiment, the non-local storage occurs in network-attached memory which requires one hundred cycles to perform a memory access. Because an access for Thread 0 in table Y requires 100 cycles to read an individual piece of data, the performance for Thread 0 will be much lower (the number of cycles per iteration in the loop 770-780 will be higher).

Threads 0-7 then proceed to step 760, where each threads 0-7 initialize their private table Y with random data. This random data is within a certain range such that any value retrieved from the table can serve as an index within the table. For example, in this illustrative embodiment, the 128 KB table is filled with 32768 entries of 4-bytes each, and each entry in a table Y is a value between 0 and 32767. These random values will be different for each thread's table Y.

Next, threads 0-7 proceed to step 765, where private variable R is initialized to a random value between 0 and 32767. This random value is different for each thread, which is achieved by different seeds for each thread for use in the pseudorandom number generator. Threads 0-7 then proceed to begin a loop starting with step 770. In step 770 threads 0-7 initialize a loop variable J which is private for each thread. This variable is used in steps 770 and 780 to loop through steps 770-780 for 2̂47 times (approximately 10̂14). At approximately 100 trillion, the loop is executed many more times than the number of accumulations performed in step 716, and therefore performance in the 770-780 loop is much more important than performance in steps 715-716. For example, a reduction in the number of cycles required to execute steps 770-780 from 10 cycles to 5 cycles would result in a decrease in the program's time to completion of approximately 50%, and therefore an increase in performance of 2×. In contrast, a reduction in the number of steps for an accumulation operation within step 716 from 10 cycles to 5 cycles would result in less than a 1% increase in overall performance for thread 0.

Within the loop of steps 770-780 executed by each of threads 0-7, step 775 contains an operation in which a value at a random index within table Y is retrieved from memory. For threads 1-7 this might take 1 cycle because table Y is stored in local memory, but for thread 0 this could take 100 cycles because the value is retrieved from network-attached memory. Because the value is retrieved from a random index, it is impossible to predict what data will be needed next. Therefore, the fetching of larger chunks of contiguous table entries does not benefit the performance of the memory reads performed by Thread 0 in step 775. If, however, the accesses were contiguous instead of random, then it would be possible to fetch multiple table entries at once, saving the additional entries for use in subsequent iterations of the 770-780 loop, and decreasing the number of cycles per loop iteration for thread 0 from 100 to 50 or less, thereby at least doubling performance. Thus, it is clear that the method by which a data structure is accessed (random or contiguous) is an important indicator in determining the performance of memory accesses.

Threads 0-7 then proceed to step 780 which, for the first approximately 100 trillion times will proceed via arrow 782 to step 770. After many executions of the loop execution will eventually proceed from 780 to step 785 via arrow 784. In step 785, the value S is stored to persistent storage for later use. After this, execution proceeds to step 790 and ends for threads 0-7.

Referring now to Threads 8-11, which proceeded from step 718 to step 720 via arrow 717, upon execution of step 720 threads 8-11 each create an individual private table named table “X”. Table X is 1 Gigabyte (GB) in size, significantly larger than the 256 KB per thread that is available in local memory. Therefore, Table X must be allocated in network-attached memory. Threads 8-11 next proceed to step 725 in which they initialize each of their X tables from the network. Each table holds different information for each thread. Next, execution proceeds to step 730, in which an outer loop variable J is initialized so that the outer loop 730-750 executes 2̂25 times. Each thread is initialized to parse a different portion of table X. Threads 8-11 next proceed to initialize the inner loop variable K in step 735, which will control the inner loop iterations comprising steps 735-745. In step 740 values X[J] and X[K] are retrieved. Note that if J or K are larger than the maximum index in table X they are converted temporarily to an index that is the remainder (called the “mod” operation) after dividing by the size of X. The value X[J] need only be loaded once per outer loop iteration, but must be loaded once for each iteration of the inner loop. Thus X is accessed in order, so that each entry is retrieved in turn. For example, value at index 0 is retrieved during the first iteration, value at index 1 is retrieved during the second iteration, and so on. This is called a contiguous memory access and indicates that a larger chunk of memory can be fetched at once in order to increase performance. In this illustrative embodiment the program would need special rewriting in order to load multiple values from table X during a single memory operation. Because this rewriting does not exist in this embodiment, a performance penalty for accessing the table X, which resides in network-attached memory, has a cost of 100 cycles per access. Note that in alternative architectures it is possible that the contiguous values are retrieved automatically, without special rewriting of the program, and it is possible for the program to run with much better performance on such architectures without the rewriting process.

Execution for threads 8-11 then proceeds to step 745, which will proceed via arrow 747 to step 735 for many inner loop iterations, and then escape to step 750 after 2̂27 iterations. In step 750 execution will proceed to step 730 via arrow 752 for the first 2̂25 iterations of the outer loop, before finally proceeding to step 785 via arrow 754. Similar to threads 0-7, threads 8-11 store the value of S to persistent storage which can be accessed later, and then execution proceeds to step 790 where the program ends.

The memory allocations of steps 714, 720, and 755 can include a logging feature which is written to during execution of those steps to indicate where the data structure is stored. Additional information such as the program counter (which indicates what step is performing the allocation) as well as the time the step is initiated and how long the step takes may also be stored. This is also true for memory accesses such as at steps 716, 740 and 775, whereby the logging indicates the program counter (which step or line of code is being executed during the logging entry), the time, and the amount of delay that occurred during the completion of the memory operation.

FIG. 8 shows the log for Thread 0 of the program of FIG. 7. Entry 805 logs the start of the execution of the program, which includes a time that can be subtracted from other log entries in order to arrive at the difference in time between the log entry and the start of the program. This subtraction has already been performed and is reflected in the times shown in FIG. 8. Entry 810 shows the allocation of Table T at step 714. The local memory for thread 0 starts at 0x0F000000 and includes 256 KB such that all addresses up to, but not including address 0x0F040000, are included in the local memory for thread 0. However, since the local memory must also store miscellaneous data such as the thread 0 stack variables, less than 256 KB are available for allocating table data structures. In step 714 table T is allocated for thread 0 at 0x0F000000 and includes all memory up to, but not including address 0x0F020000.

Entry 815 shows a memory read at 0x0F000000. The access is to local memory so the memory read finishes quickly and the wait time is 0. Log entry 820 shows a read at 0x0F000004, which is a consecutive memory address (i.e., a contiguous memory read). When accessing local memory as in entry 820, both random and consecutive memory accesses are performed quickly and this is indicated by the wait time of zero. Many such contiguous memory accesses occur, as indicated by the ellipsis below log entry 820, until the final access to table T is performed by thread 0, at address 0x0F01FFFc, shown in entry 825. This results in the 32770^{th} log entry for thread 0. Next, thread 0 allocates a second 128 KB data structure in table Y, shown at entry 830. Because table T is occupying local memory there is no room in thread 0's local memory for table Y. Therefore table Y is allocated in network-attached memory, which is indicated by the address 0x80000000. Note that although 32-bit addresses are used in this illustrative embodiment, the invention can also make use of 64-bit addressing. After this, entries 840-845 shown random accesses to table Y, which require wait times of 100 cycles for each access, thereby causing the time of log entry 10̂8 to occur around the time 10̂10, shown in entry 845. Execution finally completes at 850. It is noteworthy that if table Y had fit in local memory then wait time for entries 840-845 would have been zero and the time in log entry 845 would have been approximately 100× less, equal to approximately 10̂8. This would be a 100× performance improvement and is dependent upon proper memory allocation.

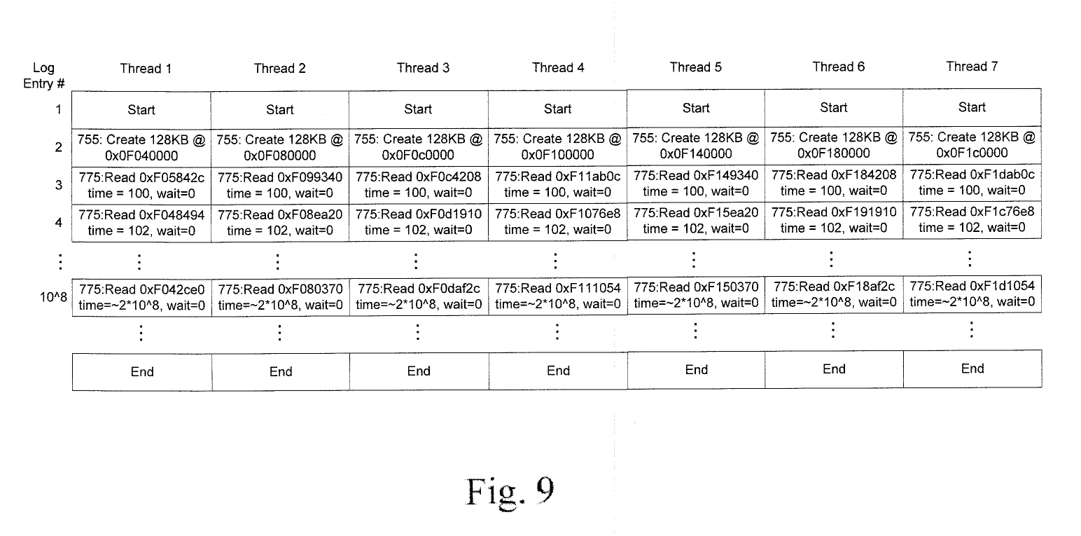

FIG. 9 shows seven separate logs in seven separate columns, with each column corresponding to a different thread log. The log entries for Threads 1-7 are similar to those of Thread 0 in FIG. 8, but include an additional row, row 4, which shows one additional iteration before the ellipsis. There are several key differences between the log of FIG. 8 and the logs of FIG. 9. First, the allocations in row 2 are made to the different local memories for each thread which start at the different addresses of 0x0F040000, 0x0F080000, . . . 0x0F1c0000. The accesses of rows 3, 4, and 5 are to different random addresses, showing that the threads are accessing different indexes in their respective tables. Second, the wait times of rows 3, 4, and 5 are zero because each of threads 1-7 in FIG. 9 are accessing their respective local memories, whereas delays for the same step 775 for thread 0 in FIG. 8 required 100 cycles each.

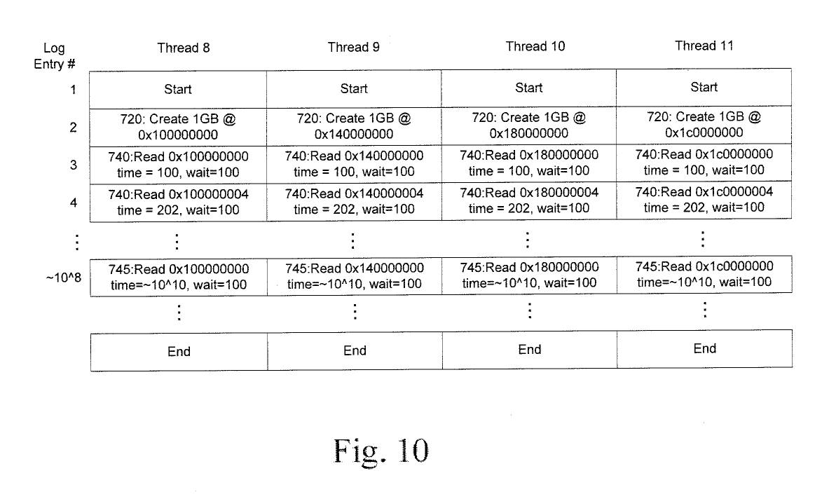

FIG. 10 shows logs for Threads 8-11 of the program of FIG. 7. The four columns of FIG. 10 corresponds to the four logs for Threads 8, 9, 10 and 11. The allocation in row 2 shows the creation of the much larger 1 GB data structure. This data structure is unshared and so resides at different 64-bit addresses of 0x100000000, 0x140000000, 0x180000000, and 0x1c0000000 for threads 8, 9, 10, and 11 respectively. Note that the wait times for memory reads in rows 3, 4 and 5 are 100 cycles, which is due to the data structure table X, allocated in step 720 of FIG. 7, being in network-attached memory. Threads 8-11 access table X at consecutive addresses, as indicated by the addresses in row 4 being just 4 greater than the addresses in row 3, for corresponding columns. The information that these accesses are contiguous will be useful during analysis for determining whether these threads might work better on serial hardware.

FIG. 11 shows the first stage of an analysis performed by an analysis program in accordance with a preferred embodiment of this invention. In the first stage, data structures are created for processing in the second stage, shown in FIG. 12. The analysis process starts at step 1100 and immediately proceeds to step 1110, which begins a loop that iterates through each thread's individual log separately. It is noteworthy that it is possible to save data from one log and use it in another log—for example the location of a data structure may only be recorded in one of the logs even if it is used by multiple threads. Furthermore, it is possible to search through the other logs to find the declaration of a variable so that it is known what variable is being referred to during a memory access at a given address. The analysis proceeds to step 1120, unless all threads have been processed in which case the analysis process proceeds to “End” via the “No more thread logs” arrow.

For each thread, step 1120 of the analysis process begins a loop through all of the memory operations in the log for that thread, including memory allocation and memory accesses. The illustrative embodiment uses log entries for all memory reads but no memory writes; however, it is possible to log memory writes when they can result in preventing further progress of the thread (such prevention of progress is called “blocking”). This can happen, for example, when the memory reference is to a non-local memory address and the network-on-chip 2410 is highly congested. Similarly, it is possible to not log memory references to local memory addresses since these do not result in a performance penalty. This can result in reduced logging burden and shorter logs; however, it can also result in erroneous optimizations that do not appropriately appreciate the performance of efficient memory references that are already made to local memories.

If there additional memory references to be processed for the current thread log, analysis proceeds from step 1120 via arrow 1127 to step 1130. If no other memory references are left, analysis returns to step 1110 via arrow 1125. In step 1130, the type of memory operation for the memory access is analyzed. If the memory operation is the creation of a new memory allocation, then the analysis proceeds to step 1140 via arrow 1135. In step 1140, a new entry for the new data structure allocation is entered into the allocation list along with the specifics as to the properties of the allocation (e.g., base address, size and the like). A list of memory accesses to the data structure is initialized to be empty and included in the new allocation list entry. The process then returns to step 1120.

If, on the other hand, the memory operation analyzed in step 1130 is not a new memory allocation then the process proceeds to step 1150 via arrow 1137. At step 1150, the data structure to which the address of the memory operation refers to is identified in the allocation list. The data structure can be identified using the base address and size, which is catalogued for each entry in the allocation list. It is possible to sort the allocation list by base address in increasing order. When sorted, the latest entry that is less than or equal to the address of the memory operation is the only one in the allocation list that may contain the data structure to which the memory operation refers. If the base address of the data structure plus its size is greater than the memory operation address then the memory operation refers to that data structure. Otherwise the data structure to which the memory operation refers is not in the allocation list and was either allocated by a different thread that has not yet been processed, or the memory reference is erroneous (or alternatively to the null address). If the correct data structure is not in the allocation list then the analysis process for the current thread can be suspended and the next thread log can be jumped to. The analysis of this suspended thread can then be continued later after the other threads have been analyzed (some of which may themselves have been suspended). If the memory operation is to an allocated data structure, then the entry will be in the allocation list after the other logs have been processed and the analysis of the current thread can proceed.

After step 1150, the analysis proceeds to step 1160 where a new entry in the data structure's usage list is added. The new entry includes information about the current memory operation such as its address, the amount of wait time and the like. This information is analyzed in the second stage to detect, for example, contiguous and random memory accesses, as well as candidate data structures for alternate allocation specification. After step 1160, the analysis process returns to step 1120. During the final processing of data in stage one, the analysis process will then proceed to step 1110 via arrow 1125 and then to “End” via “No more thread logs.”

Referring now to FIG. 12, the second stage of the analysis process is shown. The second stage uses as input the allocation list (and constituent usage lists) created by the first stage, shown in FIG. 11. The second stage of the analysis starts at step 1200 and proceeds immediately to step 1205. Step 1205 begins a loop through the allocation lists created by each thread and proceeds to step 1210. If all threads' allocation lists have been processed, the process proceeds to step 1260 via arrow 1255.

In step 1210, the process begins a loop that will iterate through each data structure entry in the current thread's allocation list. Next, at step 1215, the process analyzes whether the current data structure is shared amongst multiple threads and if so, proceeds to step 1230 via arrow 1218. At step 1230 the “size” of the data structure is calculated as the number of bytes of the data structure divided by the number of threads that share the data structure. If in step 1215 the data structure is found to not be a shared data structure, then the analysis process proceeds to step 1220 via arrow 1217. In this case, the “size” value is set to the number of bytes of the data structure and the analysis proceeds to step 1225. Both steps 1220 and 1230 then proceed to step 1225.

Having arrived at step 1225 from either step 1220 or 1230, the “Oversize ratio” value is calculated as the “size” value divided by the amount of local memory per thread. In this way the analysis process can be calibrated for various kinds of parallel hardware that contain different amounts of local memory. Thus, the “Oversize ratio” represents the overhead factor of allocating local memory to the data structure and deactivating the threads that would normally use those local memories. Higher “Oversize ratio” indicates a lower performance per unit of parallel hardware and allocation optimization is not likely to be helpful. Lower “Oversize ratio” indicates that a data structure is a good candidate to be moved to local memory.

Proceeding to step 1235, the “Total Wait” variable is calculated as the sum of all waits in the usage list. Next, at step 1240 the “Wait ratio” is calculated. The “Wait Ratio” helps determine to what extent accesses to the current data structure represent a bottleneck for the performance of the program. At step 1240, the “Wait ratio” is calculated as the total number of wait cycles divided by the total non-wait cycles (total cycles−total wait). Thus, the “Wait ratio” value is equal to 1 when half of the execution time of the program is spent waiting for the operations on the current data structure. A “Wait ratio” of 4 is achieved when 80% of the total number of cycles required for the thread to finish the program are spent waiting for operations on the current data structure. We can see that higher “Wait ratios” indicate that optimizations to the data structure's allocation are more likely to result in significant overall performance improvements.

Threads accessing a data structure found to be 1) a performance bottleneck from its “Wait ratio” and 2) not to benefit from allocation optimization by its “Oversize ratio” may be good candidates for moving to serial hardware. To further determine whether this is the case, analysis proceeds from step 1240 to step 1245. At step 1245, the “Random ratio” is calculated as the percentage of memory accesses that are non-sequential to the current data structure by the current thread. A “Random ratio” of 100% indicates that the previous memory access to the data structure by the current thread is highly unlikely to be adjacent in memory to the subsequent memory access. In contrast, a low “Random ratio” (e.g., 1%) indicates that memory operations on the current data structure are almost always preceded by memory operations to adjacent memory addresses.

High “Random ratios” indicates that serial hardware that prefetches data from memory into cache in order to eliminate latency penalties will be successful (i.e. that serial hardware is well-suited for these accesses). The latency penalty would arise if a round-trip communication from the thread's processor, to DRAM, and back to the processor was required for every access to the data structure. In contrast, contiguous memory accesses, which are indicated by high random ratios near 100%, are well served by the caching built into serial hardware. It is noteworthy that through special programming it is possible to move data from network-attached memory in blocks larger than single values so that parallel hardware can effectively benefit from contiguous memory accesses and avoid latency penalties. Indeed, the current invention includes detection of these contiguous memory accesses so that suggestions can be made to the user as to how the program might be modified to avoid memory latency penalties. However, since network-attached memory must be accessed through the server-to-server network, parallel hardware will still be unsuited for such memory accesses when higher memory bandwidth is required because server-to-server bandwidth is significantly less than typical DRAM memory bandwidth on serial hardware.

The second stage of analysis proceeds from step 1245 to step 1250, where a “Serial Priority” is assigned to the data structure. The “Serial Priority” is generated from the Oversize ratio, Wait ratio, and Random ratio. An example equation that can generate the Serial Priority is: Serial_Priority=(1−Random_ratio)*Min(Wait_ratio, Oversize_ratio), where Min is the minimum function and returns the least of its inputs. Higher Serial Priority figures are generated for data structures whose threads that access it are good candidates for execution on serial hardware instead of parallel hardware.

The analysis then proceeds from step 1250 to step 1210. When all entries have been processed for the current thread, the analysis proceeds from step 1210 to step 1205 via arrow 1207. Step 1205 iterates through all of the thread's allocation lists until there are no more allocation lists to process, in which case the analysis proceeds through step 1255 to step 1260. Step 1260 selects an algorithm for use in segregating the threads into parallel hardware and serial hardware groups based on the Serial Priority values of the data structures (and the thread's use of those data structures). Note that it is possible for one data structure to contain multiple Serial Priorities when that data structure is shared by multiple threads. In this case the Serial Priority represents the likelihood that a particular thread's accesses would be improved if the data structure and thread resided and executed on serial hardware.

An example algorithm for step 1260 is an algorithm that assigns all threads that access a data structure with a Serial Priority greater than 4.0 to serial hardware, and all other threads to parallel hardware. Multiple algorithms in step 1260 result in multiple candidate segregations, through the iterative process of steps 1260-1267. In step 1265 the performance, performance-per-watt, and performance-per-dollar of the segregation from step 1260 is predicted using a model for how well the serial hardware would improve (or worsen) upon the wait times of the memory operations performed by the threads assigned to serial hardware. After predicting the performance of multiple candidate segregations, a segregation is selected for testing and the analysis progresses to step 1270 through arrow 1268. If the selected segregation is not predicted to deliver significant performance over the currently chosen segregation, then the analysis process proceeds through arrow 1273 to step 1280. If the new segregation is expected to deliver sufficiently better performance then the analysis proceeds from step 1270 to step 1275 through arrow 1272.

In step 1275 the program is run on a combination of serial and parallel hardware according to the selected segregation, the performance of the memory operations and potentially the work unit completion (discussed below) is observed. Analysis then proceeds from step 1275 to the first stage of analysis in 11 and then back to step 1205, as indicated by the arrow from 1275 to 1205.

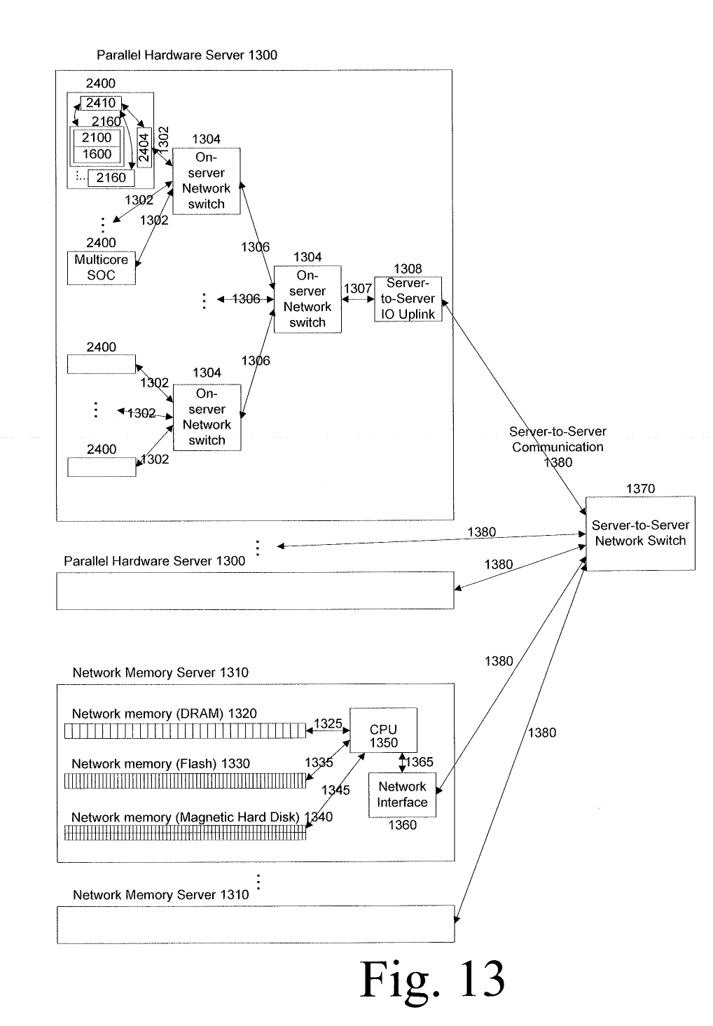

FIG. 13 shows an illustrative embodiment of the parallel hardware system of FIGS. 2-6, demonstrating the difference between memory operations with varying degrees of locality. The latency, available bandwidth and optimal chunk size for memory transfers differs based on the level of locality. In the illustrative embodiment, local memory accesses are performed when a memory generated from a processor core 1600 operates on an address residing in the locally connected memory 2100. For this type of access, when a virtual processor 2281-2288 accesses its assigned local memory bank 2110-2116 (not shown), the latency is zero and the bandwidth is unlimited.

A second degree of locality may be considered when a virtual processor accesses a local memory bank to which it is not assigned, as where Virtual Processor #2 2282 accesses DRAM Bank 2110. Here the memory latency can be a variable, typically two cycles, and bandwidth is approximately half in the typical case.

A third degree of locality may be considered when a virtual processor in a core 1600 accesses a memory bank 2100 local to a different core on the same chip. In the case of a memory read operation, the core 1600 sends the data request through the network-on-chip 2410 to another bank of memory on chip 2100. The memory operation then waits at the target memory bank until a cycle occurs where the bank is not being used by the local core, and then the operation is carried out. For a memory read, the data then proceeds through the network-on-chip 2410 and back to the core 1600. In this case, latency of the memory access is also dependent upon the latency and bandwidth supported by the network-on-chip 2410, as well as congestion of the network-on-chip 2410 and the non-local memory 2100. Typical values might be an aggregate bandwidth availability between all cores of 80 gigabits per second (gbps) and round-trip latency of 4 cycles.

A fourth degree of locality may be considered in which a core on one chip 2400 accesses the memory bank residing on a different chip 2400. This case is the same as the third case except that when data traverses through the network-on-chip 2410 in the third case it also travels through a connection 1302 to an on-server network switch 1304 and back to the core 1302. Each chip may only have a total of 2 Gigabytes per second of bandwidth and latency may be on the order of 10 cycles for memory reads in this case.

A fifth case exists similar to the fourth case except that whereas memory operations previously passed through only one on-server network switch per direction, they now pass through two hierarchy levels and three switches 1304 using links 1306 that connect switches 1304 to each other. Latency in this scenario might be 60 cycles for round trips and a chip's 2400 bandwidth allocation might be 1 Gigabyte per second of bisection bandwidth.

A sixth case exists similar to the fifth case, with the pathway additionally including passage through a server-to-server uplink 1308 via a connection 1307. This case also includes the path from said server-to-server uplink 1308 to a network interface 1360, where data is transferred through 1365 to the CPU 1350 of a Network memory server 1310, where memory is operated on in DRAM 1320, Flash 1330, or Magnetic Hard Disk 1340. This path also includes transitions through server-to-server network switches 1370 and connections 1380. Each of the different kinds of memories on the Network memory server 1310 have different performance and latency characteristics. The selection of which memory to use is based on the size of the data structure (i.e. DRAM 1320 is used unless the structure cannot fit in DRAM in which case it is held in Flash 1330 or Hard Disk 1340). This path is traversed again for round-trip memory read accesses and may take around 100 cycles of latency and have only 4 Gigabytes per second of bandwidth per Parallel Hardware Server 1300.

The pathways in FIG. 13 demonstrate how the performance characteristics of memory accesses vary based on the locality of the data being accessed in a parallel hardware 1300 embodiment.

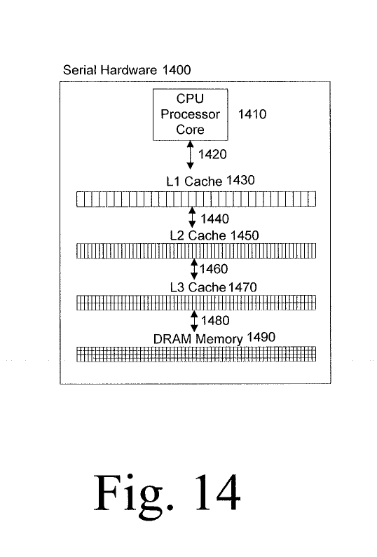

FIG. 14 shows how the performance characteristics differ for a serial hardware 1400 embodiment. In FIG. 14, the CPU processor core 1410 communicates with DRAM memory 1490 through a number of intermediary caches. The caches are responsible for storing data that is likely to be requested in the near future closer to the processor. The performance characteristics of the memory system 1420-1490 within the serial hardware 1400 is much different from the memory system in the parallel hardware 1300. Memory fetches from the L1 cache 1430 passing through the connection 1420 have a latency of 2-3 cycles, and these cycles can often be hidden by the out-of-order engine built into the CPU processor cores 1410 of serial hardware 1400. The out-of-order engine moves on to program instructions before previous instructions have completed so that multiple memory operations can be in the process of being completed simultaneously. Memory fetches to the L2 cache 1450 through the additional connection 1440 that are random can be served in typically 10-14 cycles of latency. However, predictable memory operations will typically be prefetched into the L2 cache 1450 from the L1 cache 1430 resulting in a maximum access time of 2-3 cycles. Random memory reads to the L3 cache 1470 travel through an additional connection 1460 and have a typical latency of 40 cycles. Predictable memory references in the L3 cache 1470, however, can be prefetched into the L2 cache 1450 or the L1 cache 1430 with a minimum penalty of 2-3 cycles. Finally, random memory accesses to the DRAM memory 1490 pass through an additional connection 1480 and have latency on the order of 100 cycles. However, predictable memory references to the DRAM memory 1490 can be prefetched to the L3 cache 1470, the L2 cache 1450, or the L1 cache 1430, resulting in a penalty as low as 2-3 cycles.

Two differences between FIGS. 13 and 14 are also noteworthy. The DRAM memory 1490 can be 24 GB or larger and have 12 GB/sec of bandwidth or greater. This bandwidth is much greater than the sever-to-server bandwidth available to Parallel hardware servers. Furthermore, the optimal chunk size to the DRAM memory 1490 may be on the order of 128 bits, whereas the optimal chunk size for fetching of data from the network-attached Flash memory 1330 is typically 4 Kilobytes or more.

FIG. 15 shows the specification report resulting from having analyzed the execution logs of FIGS. 8-10 based on the analysis of the first stage of FIG. 11 and the second stage of FIG. 12. The specification report is based on parameters for the analysis derived from the memory performance characteristics of the parallel hardware 1300 shown in FIG. 13 and the serial hardware 1400 shown in FIG. 14. The specification generated in FIG. 15 segregates the threads so that some threads (i.e., threads 0-7, rows 1-8) execute on the parallel hardware 1300, and other threads (i.e., threads 8-11, rows 9-12) execute on the serial hardware 1400. In future runs, the program may include additional logging to monitor when a work unit has been completed so that the resulting performance of the program on the serial hardware 1400 (where memory performance logging features may not exist) can be compared directly with the performance on the parallel hardware 1300.

FIG. 15 also shows the line of code (middle column) that is most responsible for the decision of whether that thread should run on parallel or serial hardware. Threads 0-7 spent most of their execution performing the memory operation of program code line 775. Except for thread 0, the memory access of 775 was sufficiently efficient so that execution on serial hardware was unnecessary. In the case of thread 0, we will see that an alteration to the memory allocation for thread 0 is recommended that will allow efficient execution on parallel hardware. Threads 8-11 were selected for execution on serial hardware due to the memory access of program code line 740, which was a predictable memory access into a 1 GB data structure.

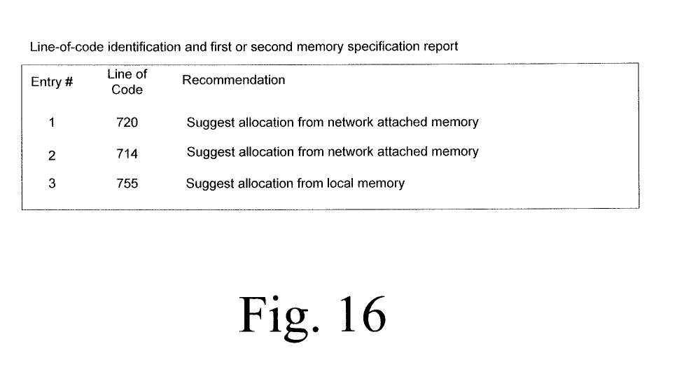

FIG. 16 shows an example report of suggested alternations to the program of FIG. 7 that can improve performance, determined based on the analysis of the analysis program of FIGS. 11 and 12. Entry #1 of the report shows that the line of code 720 should be altered to include a suggestion to the memory allocator that table X be stored in network attached memory. In fact this structure was already allocated to network-attached memory in the previous run, but the modification to the program allows the programmer to understand where the memory is being allocated. This may indicate to the user an insight that may lead to deeper changes to the program that are not detected by the system, but can be carried out by the user to create substantial performance improvements.

Entry #2 of the report suggests that line-of-code 714 should be allocated to network-attached memory. This is a key improvement that would allow the vast majority of memory operations for thread 0, carried out in step 775 of FIG. 7, to operate on local memory instead of network-attached memory, thereby increasing the performance of thread 0 some 50×-100×.

Entry #3 of the report indicates that Table Y, allocated in line of code 755, should be allocated from local memory. This was the case in the initial run for all relevant threads except thread 0. By freeing up local memory with the suggestion in Entry #2, the suggestion for entry #3 can be followed for thread 0 and performance will be increased, as described above.

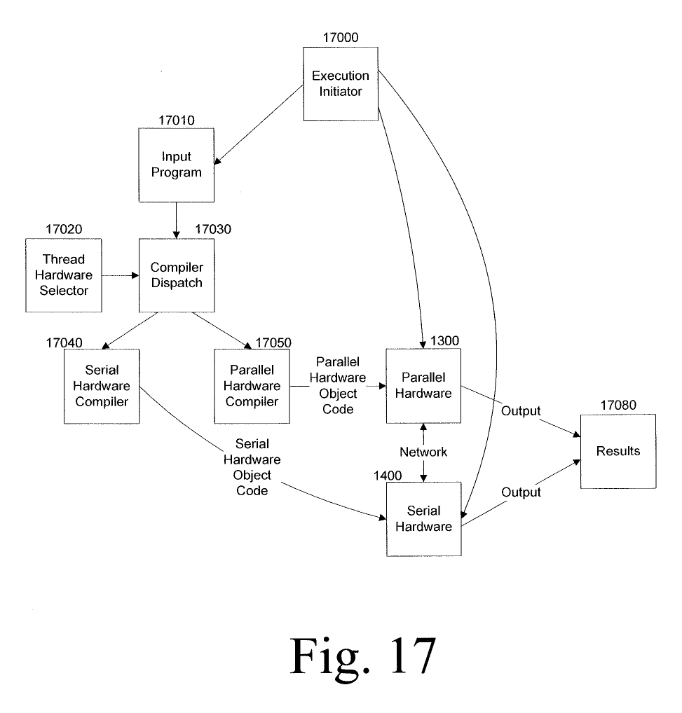

FIG. 17 shows the process of executing a program on the parallel hardware 1300 and the serial hardware 1400, given the thread hardware specification shown in FIG. 15. When a user initiates execution, the execution initiator 17000 sends the input program 17010 specified by the user to the compiler dispatch 17030. The user may have initiated execution with a command such as “cogexec program.c”, in which case 17010 would then be program.c. Compiler dispatch 17030 receives the input program 17010 and compilation command. Thread hardware selector 17020 uses the thread hardware specification of FIG. 15 to direct the compiler as to what components of program.c must be compiled for parallel hardware 1300 using the Parallel hardware compiler 17050. The compiler dispatch 17030 also directs the serial hardware compiler 17040 as to which components of program.c must be compiled for serial hardware 1400. It is possible that the program.c file includes compiler details such as “#pragma” commands that delimit which sections of code do not need to be compiled for parallel hardware and which sections do not need to be compiled for serial hardware. Such commands may be embedded in program.c through previous optimizing runs, possibly with more verbose logging enabled to unambiguously detect which code is executed by which threads.

The parallel hardware compiler 17050 compiles program.c into parallel hardware object code, which is then sent to the parallel hardware 1300 and executes on a recruited set of parallel hardware, as directed by the execution initiator 17000. The serial hardware object code is generated by the serial hardware compiler 17040 and is sent by the serial hardware compiler 17040 to the serial hardware 1400. The serial hardware object code then executes on a recruited set of serial hardware 1400, as directed by the execution initiator 17000. Parallel hardware 1300 and serial hardware 1400 communicate with each other via a network during execution and send their results output to results storage 17080.

One step in the process by which the execution initiator directs the parallel hardware and serial hardware may be encapsulated by an “mpirun” command that designates a set of threads to run on parallel hardware and a different set of threads to run on serial hardware. An example mpirun command executed by the execution initiator might be:

“mpirun -arch cognitive -np 8 program.cognitive -arch x86-np 4 program.x86”

which designates processes 0-7 to execute on cognitive hardware and processes 8-11 to execute on x86 serial hardware.

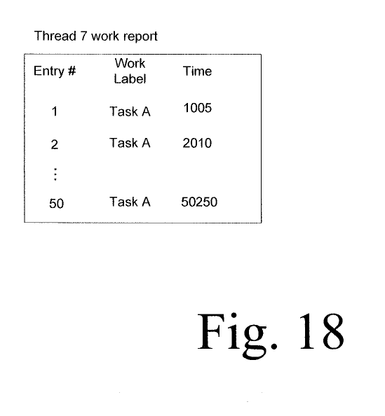

FIG. 18 shows an example work report generated by thread 7 of the execution of the program of FIG. 7. To report such work, additional logging functionality might be included by the user, for example, in the input program.c source code, such as in steps 775 or 740. Such logging functionality would report when a unit of work completes, and these reports can be compared in terms of time-between-work-units between the serial hardware 1400 and parallel hardware 1300. In this way, the system can verify performance predictions. When the performance is less than predicted, the system can rollback to a previous thread hardware specification that resulted in higher performance. Furthermore, the prediction system's parameters (e.g. L1 cache latency) can be updated to fit the results of the system so that the performance predictions become increasingly accurate. Parameters may be adjusted using any number of fitting algorithms. For example, a genetic algorithm could be used to derive new parameters for the performance prediction model. When performing such fitting, it is important to note that the feedback loop through which the model improves does not use the final performance of a user program directly, but instead subtracts the expected performance from the predicted performance to control the model fitting.

FIG. 18 shows the work report for thread 7. The work report includes a list of 50 entries. Entry #1 shows that Task A was completed at time 1005. Entry #2 shows that Task A was completed again at time 2010. This proceeds similarly for the entries 3-49, with each entry completed 1005 cycles after the one before it. Finally, entry #50 shows that Task A was completed a 50th time at time 50250. After moving thread 7 from the parallel hardware 1300 to the serial hardware 1400, or from the serial hardware 1400 to the parallel hardware 1300, Task A can be expected to still be performed 50 times. That is to say, the program will complete Task A 50 times regardless of what hardware it is running on. An exception exists when the program chooses to do more work when more time is available. When run on different hardware, the times in the rightmost column will be higher or lower depending on how performance differed between the architectures.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An automated method of optimizing execution of a program in a parallel processing environment, the program having a plurality of threads and being executable in parallel and serial hardware, the method comprising:
(a) receiving, at an optimizer, the program;
(b) compiling the program to execute in parallel hardware upon instruction by the optimizer;
(c) executing the program on the parallel hardware upon instruction by the optimizer;
(d) the optimizer observing the execution of the program and identifying a subset of memory operations that execute more efficiently on serial hardware than parallel hardware;
(e) the optimizer observing the execution of the program and identifying a subset of memory operations that execute more efficiently on parallel hardware than serial hardware; and
(f) the optimizer recompiling the program so that threads that include memory operations that execute more efficiently on serial hardware than parallel hardware are compiled for serial hardware, and threads that include memory operations that execute more efficiently on parallel hardware than serial hardware are compiled for parallel hardware, wherein subsequent execution of the program occurs using the recompiled program.

2. The method of claim 1 wherein steps (d) and (e) further comprise each thread in the program reporting to the optimizer when it has completed a unit of work, and wherein step (f) further comprises using information obtained from the reporting to assist in identifying which threads will execute more efficiently on parallel or serial hardware.

3. The method of claim 1 wherein steps (d) and (e) further comprise identifying lines of source code that create the identified memory operations, the method further comprises:
(g) generating a report that identifies the lines of source code.

4. The method of claim 1 wherein memory operations that frequently access data in the threads that are compiled for parallel hardware are identified, and data associated with the identified memory operations are stored in first memory, and data associated with remaining memory operations are stored in second memory, wherein the first memory has a faster memory access rate than the second memory.
